(19) United States
(12) Patent Application Publication
(10) Pub. No.: US 2022/0032898 A1
(43) Pub. Date: Feb. 3, 2022

(54) VEHICLE, SERVER, AND INFORMATION PROCESSING SYSTEM

(71) Applicant: TOYOTA JIDOSHA KABUSHIKI KAISHA, Aichi (JP)

(72) Inventors: Yoshiaki MIYAZATO, Sunto-gun (JP); Atsuharu OTA, Mishima-shi (JP); Daiki YOKOYAMA, Gotemba-shi (JP); Yoshiyuki KAGEURA, Sunto-gun (JP); Masanori SHIMADA, Susono-shi (JP); Yoshihiro SAKAYANAGI, Mishima-shi (JP); Hiroki MORITA, Hiratsuka-shi (JP)

(21) Appl. No.: 17/369,955

(22) Filed: Jul. 8, 2021

(30) Foreign Application Priority Data
Jul. 29, 2020 (JP) 2020-128715
Apr. 19, 2021 (JP) 2021-070713

(51) Int. Cl. B60W 20/12; B60W 10/24; B60W 30/182

(52) U.S. Cl. CPC B60W 20/12; B60W 10/24; B60W 30/182; B60W 2556/45; B60W 2710/06; B60W 2710/08; B60W 2555/60

(57) ABSTRACT

A vehicle includes: an electric motor; a storage battery configured to supply electric power to the electric motor and be charged with electric power from an external power source; an internal combustion engine configured to rotate the electric motor; and a controller configured to perform an electric power generation control and a prohibition control, the internal combustion engine being prohibited in a case where the vehicle is positioned in a predetermined region, wherein the electric power stored in the storage battery is suppliable to an outside, and the controller is configured to permit driving of the internal combustion engine even in the predetermined region in a case where a supply of electric power is insufficient for an electric power demand in the predetermined region or in a case where the supply of the electric power is predicted to be insufficient for the electric power demand in the predetermined region.

The present application claims priority to and incorporates by reference the entire contents of Japanese Patent Application No. 2020-128715 filed in Japan on Jul. 29, 2020 and Japanese Patent Application No. 2021-070713 filed in Japan on Apr. 19, 2021.

### BACKGROUND

The present disclosure relates to a vehicle, a server, and an information processing system.

JP H11-115651 A discloses an information processing system that performs communication between a vehicle and an information center, in which a control program for controlling a vehicle located in a predetermined area is transmitted from the information center to the vehicle. The vehicle receives the control program from the information center, and executes the control program corresponding to the area based on the current location of the vehicle.

In the configuration described in JP H11-115651 A, for example, a control program for suppressing noise and exhaust gas is transmitted to a vehicle for an area where noise or the emission of exhaust gas is limited, such as an urban district. When the vehicle that has received the control program executes the control program in the area, the driving of the internal combustion engine is prohibited, and EV driving using an electric motor is forcibly performed.

### SUMMARY

In a plug-in hybrid vehicle (PHEV) and a range extender vehicle (REEV), a storage battery may be charged with electric power supplied from an external power source. In other words, these vehicles may generate electric power with the electric motor by using the power of the internal combustion engine and supply the electric power stored in the storage battery to an external electric device (external device). Therefore, for example, at the time of occurrence of a disaster or the like, it is expected that electric power on the vehicle side is used as a power source of an external device.

However, when EV driving is forcibly performed as in the configuration described in JP H11-115651 A at the time of occurrence of a disaster, electric power is consumed on the vehicle side, and electric power on the vehicle side expected as a power source of an external device is reduced. Therefore, when electric power is required outside at the time of occurrence of a disaster or the like, it is desirable to be able to supply a large amount of electric power to the outside by utilizing a vehicle that is able to supply electric power to the outside, such as a plug-in hybrid vehicle.

There is a need for a vehicle, a server, and an information processing system, which enable a supply of a large amount of electric power from the vehicle to the outside when electric power is required outside.

According to one aspect of the present disclosure, there is provided a vehicle including: an electric motor adapted for traveling; a storage battery configured to supply electric power to the electric motor and be charged with electric power from an external power source; an internal combustion engine configured to rotate the electric motor; and a controller configured to perform an electric power generation control and a prohibition control, the electric power being generated by the electric motor by using power of the internal combustion engine, and the internal combustion engine being prohibited in a case where the vehicle is positioned in a predetermined region, wherein the electric power stored in the storage battery is suppliable to an outside, and the controller is configured to permit driving of the internal combustion engine even in the predetermined region in a case where a supply of electric power is insufficient for an electric power demand in the predetermined region or in a case where the supply of the electric power is predicted to be insufficient for the electric power demand in the predetermined region.

According to another aspect of the present disclosure, there is provided a server including a processor including hardware, the processor being configured to: acquire location information of a vehicle from the vehicle; output a driving prohibition instruction to prohibit driving of an internal combustion engine mounted on the vehicle to the vehicle located in a predetermined region based on the location information of the vehicle; and output a driving permission instruction to permit the driving of the internal combustion engine to the vehicle located in the predetermined region in a case where a supply of electric power is insufficient for an electric power demand in the predetermined region, or in a case where the supply of the electric power is predicted to be insufficient for the electric power demand in the predetermined region.

According to still another aspect of the present disclosure, there is provided an information processing system including: a server including a first processor including hardware; and a vehicle including a second processor including hardware, an electric motor adapted for traveling, an internal combustion engine configured to rotate the electric motor, and a storage battery configured to store electric power that is suppliable to the electric motor and an outside, wherein the server and the vehicle are communicable with each other, the first processor is configured to output a driving prohibition instruction to prohibit driving of the internal combustion engine to the vehicle located in a predetermined region based on location information of the vehicle acquired from the vehicle, output, in a case where a supply of electric power is insufficient for an electric power demand in the predetermined region, or in a case where the supply of the electric power is predicted to be insufficient for the electric power demand in the predetermined region, a driving permission instruction to permit the driving of the internal combustion engine to the vehicle located in the predetermined region, and the second processor is configured to prohibit the driving of the internal combustion engine in the predetermined region in a case where the driving prohibition instruction has been received from the server, and permit the driving of the internal combustion engine even in the predetermined region in a case where the driving permission instruction has been received from the server.

### BRIEF DESCRIPTION OF THE DRAWINGS

FIG. 1 is a diagram schematically illustrating an information processing system according to a first embodiment;

FIG. 2 is a diagram for describing a case where a vehicle is located in a geofence;

FIG. 3 is a diagram for describing a flow of information when a disaster occurs;

FIG. 4 is a functional block diagram illustrating an overall configuration of the information processing system;

FIG. 5 is a flowchart illustrating a control flow when the vehicle acquires location information;

FIG. 6 is a flowchart illustrating a control flow when the vehicle transmits the location information;

FIG. 7 is a flowchart illustrating a control flow when the vehicle management server updates the location information of the vehicle;

FIG. 8 is a flowchart illustrating a control flow when a disaster information server receives disaster information;

FIG. 9 is a flowchart illustrating a control flow when the vehicle management server receives disaster-stricken area information;

FIG. 10 is a flowchart illustrating a control flow when the vehicle receives a driving permission instruction;

FIG. 11 is a schematic diagram illustrating a display example of information indicating that driving of an engine is permitted;

FIG. 12 is a diagram schematically illustrating an information processing system according to a second embodiment;

FIG. 13 is a flowchart illustrating a control flow performed by a vehicle management server after occurrence of a disaster;

FIG. 14 is a flowchart illustrating a control flow performed by a vehicle after occurrence of a disaster;

FIG. 15 is a functional block diagram illustrating a configuration of a vehicle according to a first modified example;

FIG. 16 is a flowchart illustrating a control flow when the vehicle determines a schedule of restoration from a power failure; and

FIG. 17 is a functional block diagram illustrating an overall configuration of an information processing system according to a second modified example.

### DETAILED DESCRIPTION

Hereinafter, a vehicle, a server, and an information processing system according to an embodiment will be specifically described with reference to the drawings. Note that the present disclosure is not limited to the embodiments described below.

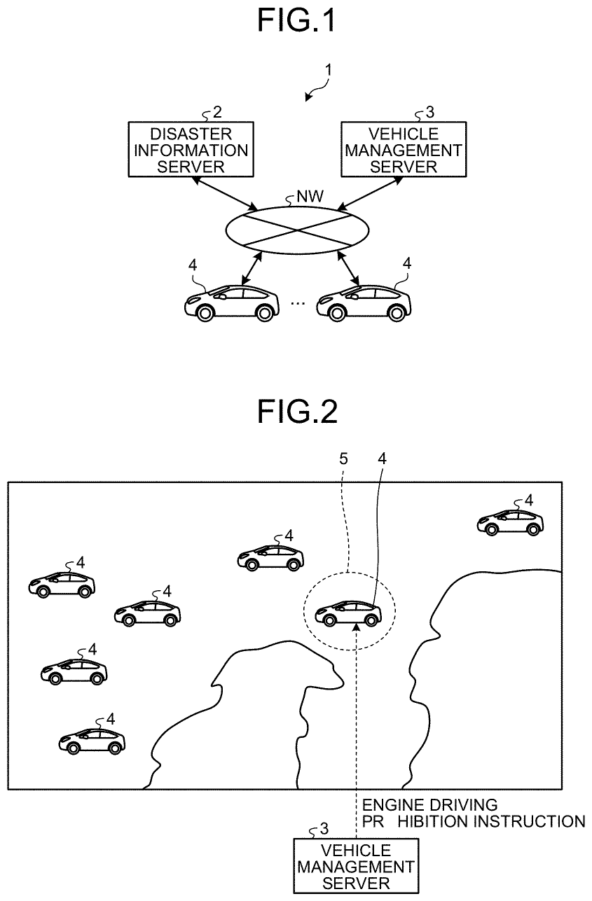

As illustrated in FIG. 1, an information processing system 1 according to a first embodiment includes a disaster information server 2, a vehicle management server 3, and a vehicle 4. The disaster information server 2 is a server installed in a disaster information center or the like. When a disaster occurs, the disaster information center sends information on the disaster. The vehicle management server 3 is a server installed in a vehicle management center. The vehicle management center monitors location information of a plurality of vehicles 4 in real time. The vehicle 4 is a vehicle that may travel (EV driving) only with power of a motor, such as a plug-in hybrid vehicle or a range extender vehicle. Further, the vehicle 4 is a vehicle that may be charged with electric power from an external power source and may supply electric power to the outside.

The disaster information server 2 and the vehicle management server 3 may perform information communication with each other via a network NW. The network NW includes, for example, an Internet line network. In addition, the vehicle management server 3 and the vehicle 4 may perform wireless communication with each other via the network NW. The vehicle management server 3 may transmit and receive information to and from the plurality of vehicles 4.

In the information processing system 1, as illustrated in FIG. 2, a virtual fence (boundary line) that is called a geofence 5 is set as a predetermined region. The geofence 5 is preset in the vehicle management server 3 for a specific region such as an urban district. That is, the vehicle management server 3 may set a plurality of geofences 5 on map information.

Then, the vehicle management server 3 causes the vehicle 4 located in the geofence 5 to perform a specific vehicle control. The vehicle control includes a power source control for controlling a power source mounted on the vehicle 4. Specifically, the vehicle management server 3 transmits, to the vehicle 4 located in the geofence 5, an instruction to prohibit driving of an engine (engine driving prohibition instruction), such that the vehicle 4 travels (EV driving) only with the motor.

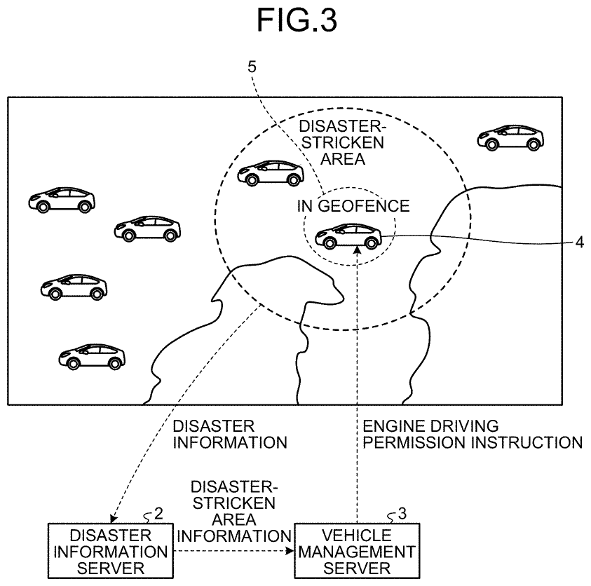

For example, when a disaster occurs, as illustrated in FIG. 3, the disaster information server 2 acquires disaster information indicating that a disaster has occurred in a predetermined area (disaster-stricken area). The disaster information server 2 provides, to the vehicle management server 3, disaster-stricken area information which is information on an area where a disaster has occurred. Upon receiving the disaster-stricken area information from the disaster information server 2, the vehicle management server 3 transmits an instruction to permit the driving of the engine (engine driving permission instruction) to the vehicle 4 located in the geofence 5 based on the information.

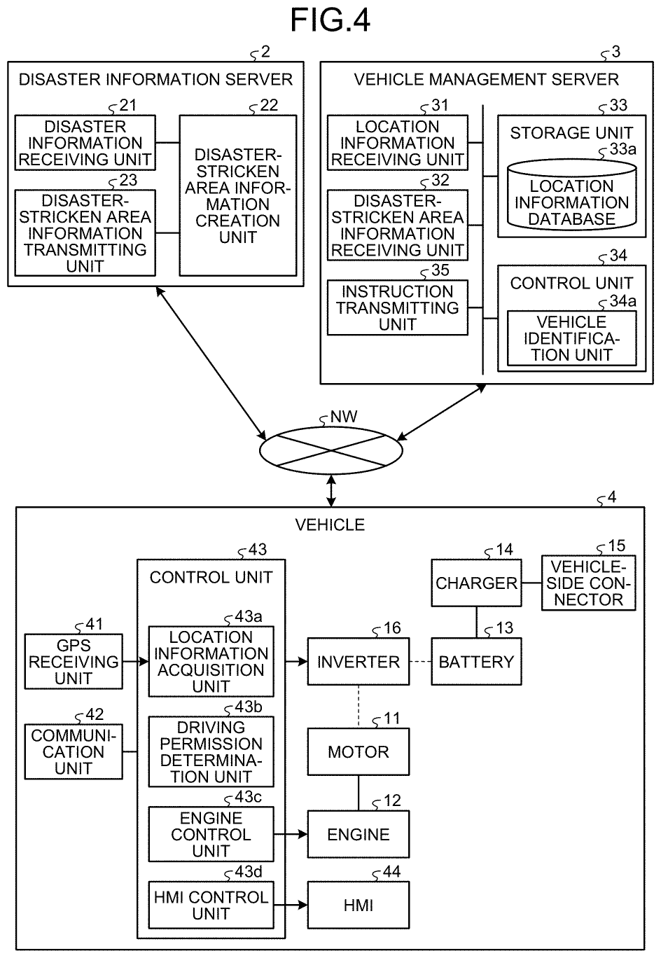

Here, an overall configuration of the information processing system 1 will be described with reference to FIG. 4.

The disaster information server 2 includes a disaster information receiving unit 21, a disaster-stricken area information creation unit 22, and a disaster-stricken area information transmitting unit 23.

The disaster information receiving unit 21 receives disaster information indicating that a disaster has occurred. The disaster refers to a situation in which damage occurs in a predetermined area due to a natural phenomenon or a human-induced cause. Examples of the disaster information include earthquake information, typhoon information, heavy rain information, flood information, tsunami information, eruption information, fire information, forest fire information, power failure information, and the like. When an earthquake occurs, for example, the disaster information receiving unit 21 receives a signal (a shake detection signal) transmitted from a seismometer installed at an observation point in each place. Further, the disaster information receiving unit 21 may receive the disaster information not only from a seismometer but also from various devices via the network NW. Moreover, after receiving information on the first report of the occurrence of the disaster, the disaster information receiving unit 21 continuously receives, as a subsequent report, newly found information such as the scale of the disaster.

The disaster-stricken area information creation unit 22 creates the disaster-stricken area information based on the disaster information. The disaster-stricken area information includes an area information indicating an area where a disaster has occurred and information indicating the scale of the disaster. When an earthquake occurs, for example, the disaster-stricken area information creation unit 22 creates the disaster-stricken area information in which a range including all observation points at which a shake of a predetermined seismic intensity or more is detected among a plurality of observation points is set as a disaster-stricken area. A predetermined area such as a prefecture, a municipal, or a district may be set as the range set as the disaster-stricken area. In addition, the disaster-stricken area information creation unit 22 sequentially updates the disaster-stricken area information to the latest information based on the subsequent reports received after the occurrence of the disaster.

The disaster-stricken area information transmitting unit 23 sends the created disaster-stricken area information. The disaster-stricken area information transmitting unit 23 transmits the disaster-stricken area information to the vehicle management server 3 via the network NW. The disaster-stricken area information transmitting unit 23 sends the latest disaster-stricken area information each time the disaster-stricken area information is updated to the latest information.

The vehicle management server 3 includes a location information receiving unit 31, a disaster-stricken area information receiving unit 32, a storage unit 33, a control unit 34, and an instruction transmitting unit 35.

The location information receiving unit 31 receives current location information transmitted from the vehicle 4. The vehicle management server 3 may receive the location information of the vehicles 4 transmitted from the plurality of vehicles 4 by the location information receiving unit 31.

The disaster-stricken area information receiving unit 32 receives the disaster-stricken area information transmitted from the disaster information server 2. The disaster-stricken area information receiving unit 32 may perform communication with the disaster-stricken area information transmitting unit 23 via the network NW.

The storage unit 33 stores various information for managing the vehicle 4. For example, the storage unit 33 stores information regarding a region for which the geofence 5 is set (hereinafter, referred to as geofence information). The geofence information is information stored in advance. In addition, the storage unit 33 includes a location information database 33a.

The location information database 33a stores the location information of the vehicle 4. On the basis of the location information received by the location information receiving unit 31, the location information of the plurality of vehicles 4 is stored in the location information database 33a in real time. That is, the location information stored in the location information database 33a is updated to the latest location information as needed.

The control unit 34 includes a processor including hardware such as a central processing unit (CPU). The control unit 34 constitutes a first processor in the information processing system 1. In addition, the control unit 34 includes a vehicle identification unit 34a.

The vehicle identification unit 34a identifies the vehicle 4 located in the geofence 5. For example, the vehicle identification unit 34a identifies the vehicle 4 located in the geofence 5 based on the geofence information stored in the storage unit 33 and the location information stored in the location information database 33a. The control unit 34 causes the vehicle 4 identified by the vehicle identification unit 34a to perform a specific vehicle control (control program).

The instruction transmitting unit 35 transmits a control instruction for causing the vehicle 4 in the geofence 5 to perform a specific vehicle control. Examples of the control instruction for the target vehicle include an instruction to prohibit the driving of an engine 12 (engine driving prohibition instruction) and an instruction to permit the driving of the engine 12 (engine driving permission instruction). As illustrated in FIG. 2 as an example, the instruction transmitting unit 35 transmits, to the vehicle 4 in the geofence 5, the instruction to prohibit the driving of the engine 12.

The vehicle 4 is an electric vehicle including a motor 11 for traveling, the engine 12, a battery 13, a charger 14, and a vehicle-side connector 15.

The motor 11 is a power source for traveling. Further, the engine 12 may rotate the motor 11. That is, the motor 11 may generate electric power by using the power of the engine 12. When the motor 11 generates the electric power by the engine 12, the battery 13 may be charged with the electric power generated by the motor 11. The motor 11 is electrically connected to the battery 13 via an inverter 16.

The vehicle 4 is a plug-in hybrid vehicle including the charger 14 that charges the battery 13 with electric power from the outside, and the vehicle-side connector 15.

The battery 13 may store electric power to be supplied to the motor 11 and store electric power supplied from an external power source. The battery 13 is connected to the vehicle-side connector 15 via the charger 14 in an energizable manner. The charger 14 charges the battery 13 with electric power from the outside. For example, the charger 14 includes various relay units. By opening the relay unit of the charger 14, the battery 13 and the vehicle-side connector 15 may be electrically disconnected from each other. When the battery 13 is charged with electric power from the outside, the relay unit of the charger 14 is closed, and the battery 13 and the vehicle-side connector 15 are electrically connected. The vehicle-side connector 15 may be connected to an outside connector such as a charging connector of a charging stand.

Further, the vehicle 4 also includes a global positioning system (GPS) receiving unit 41, a communication unit 42, a control unit 43, and a human machine interface (HMI) 44.

The GPS receiving unit 41 receives radio waves from a GPS satellite and detects the location information of the vehicle 4.

The communication unit 42 transmits and receives information to and from the vehicle management server 3. The communication unit 42 receives the control instruction transmitted from the vehicle management server 3. Furthermore, the communication unit 42 transmits the location information indicating the current location of the vehicle 4 to the vehicle management server 3.

The control unit 43 includes a processor including hardware such as a central processing unit (CPU) and a storage unit such as a random access memory (RAM) or a read only memory (ROM). The control unit 43 constitutes a second processor in the information processing system 1. The control unit 43 includes a location information acquisition unit 43a, a driving permission determination unit 43b, an engine control unit 43c, and an HMI control unit 43d.

The location information acquisition unit 43a acquires the current location information based on a signal received by the GPS receiving unit 41.

The driving permission determination unit 43b determines whether or not a driving permission instruction for permitting the driving of the engine 12 has been received from the vehicle management server 3. In a case where the driving permission instruction for the engine 12 has been received by the communication unit 42, the driving permission determination unit 43b determines that the driving of the engine 12 is permitted.

The engine control unit 43c controls the engine 12. For example, in a case where the driving prohibition instruction for the engine 12 has been received from the vehicle management server 3, the engine control unit 43c performs a prohibition control to prohibit the driving of the engine 12. Further, in a case where the driving permission instruction for the engine 12 has been received from the vehicle management server 3, the engine control unit 43c performs a permission control to permit the driving of the engine 12.

The HMI control unit 43d controls the HMI 44. The HMI 44 includes, for example, a car navigation device. The HMI 44 is an in-vehicle device that functions as a notification unit that notifies a driver of information and also functions as an operation unit that receives an operation from the driver. Further, the HMI control unit 43d controls the information to be notified from the HMI 44 according to a result of the determination made by the driving permission determination unit 43b. Information indicating a control state in which the driving of the engine 12 is permitted or a control state in which the driving of the engine 12 is prohibited is notified from the HMI 44.

Furthermore, the control unit 43 controls the motor 11 by controlling the inverter 16. Switching of the inverter 16 is controlled by the control unit 43. Furthermore, opening and closing of the relay unit of the charger 14 is controlled by the control unit 43. That is, the control unit 43 performs a charge control to charge the battery 13 with electric power from the outside, and performs a discharge control to supply the electric power stored in the battery 13 to the outside. In addition, the control unit 43 performs various controls related to the vehicle 4.

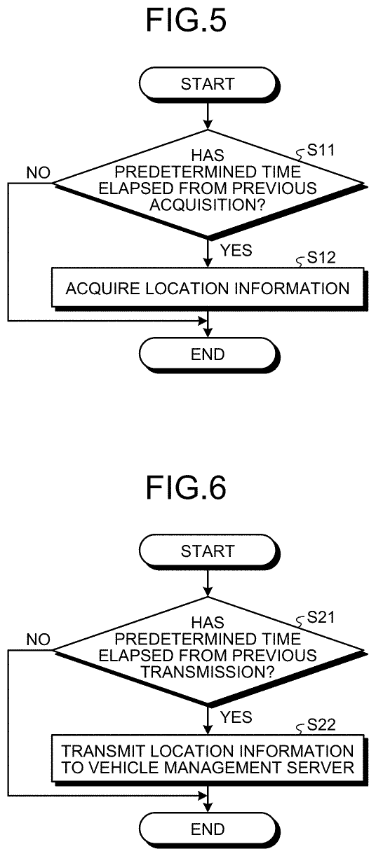

Here, a control performed by the control unit 43 of the vehicle 4 will be described with reference to FIGS. 5 and 6. Note that the control illustrated in FIGS. 5 and 6 is repeatedly performed by the control unit 43.

As illustrated in FIG. 5, the control unit 43 determines whether or not a predetermined time has elapsed from when the location information of the vehicle 4 was previously acquired (Step S11). The time when the location information of the vehicle 4 was previously acquired is a previous timing when the location information is acquired by the location information acquisition unit 43a.

In a case where the predetermined time has not elapsed from when the location information of the vehicle 4 was previously acquired (Step S11: No), this control routine ends.

In a case where the predetermined time has elapsed from when the location information of the vehicle 4 was previously acquired (Step S11: Yes), the control unit 43 acquires the current location information (Step S12). In Step S12, the location information acquisition unit 43a acquires the current location information. When the processing of Step S12 is performed, this control routine ends.

As illustrated in FIG. 6, the control unit 43 determines whether or not a predetermined time has elapsed from when the location information of the vehicle 4 was previously transmitted to the vehicle management server 3 (Step S21). In Step S21, the elapsed time from the transmission of the location information by the communication unit 42 is determined.

In a case where the predetermined time has not elapsed from when the location information of the vehicle 4 was previously transmitted to the vehicle management server 3 (Step S21: No), this control routine ends.

In a case where the predetermined time has elapsed from when the location information of the vehicle 4 was previously transmitted to the vehicle management server 3 (Step S21: Yes), the vehicle 4 transmits the current location information to the vehicle management server 3 (Step S22). In Step S22, the current location information is transmitted from the communication unit 42 under the control of the control unit 43. When the processing of Step S22 is performed, this control routine ends.

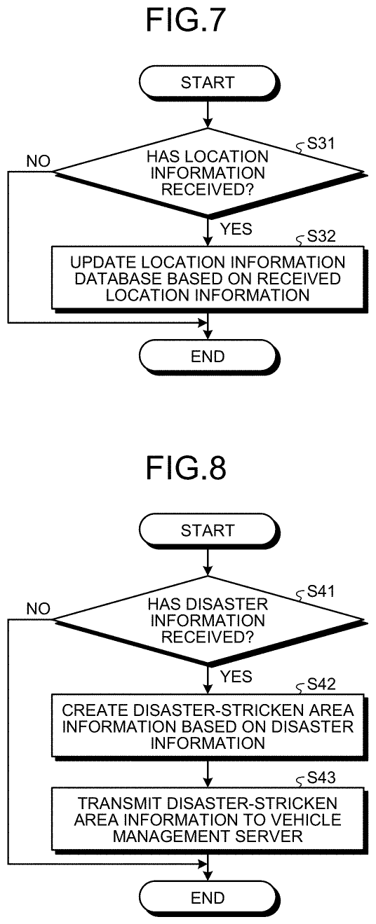

FIG. 7 is a flowchart illustrating a control flow when the vehicle management server updates the location information of the vehicle. Note that the control illustrated in FIG. 7 is repeatedly performed by the control unit 34 of the vehicle management server 3.

As illustrated in FIG. 7, the vehicle management server 3 determines whether or not the location information from the vehicle 4 has been received (Step S31). In Step S31, it is determined whether or not the location information of the vehicle 4 has been received by the location information receiving unit 31. The determination processing in Step S31 is performed by the control unit 34.

In a case where the location information from the vehicle 4 has not been received (Step S31: No), this control routine ends.

In a case where the location information from the vehicle 4 has been received (Step S31: Yes), the vehicle management server 3 updates the location information database 33a based on the received location information (Step S32). When the processing of Step S32 is performed, this control routine ends.

FIG. 8 is a flowchart illustrating a control flow when the disaster information server acquires the disaster information. Note that the control illustrated in FIG. 8 is repeatedly performed by the disaster information server 2.

As illustrated in FIG. 8, the disaster information server 2 determines whether or not the disaster information receiving unit 21 has received the disaster information (Step S41). In Step S41, for example, it is determined whether or not a shake detection signal has been received from the seismometer.

In a case where the disaster information receiving unit 21 has not received the disaster information (Step S41: No), this control routine ends.

In a case where the disaster information receiving unit 21 has received the disaster information (Step S41: Yes), the disaster-stricken area information creation unit 22 creates the disaster-stricken area information based on the disaster information (Step S42). In Step S42, the disaster-stricken area information in which a predetermined range is set as the disaster-stricken area is created based on the disaster information received in Step S41.

Then, the disaster information server 2 transmits the disaster-stricken area information to the vehicle management server 3 (Step S43). In Step S43, the disaster-stricken area information transmitting unit 23 transmits the disaster-stricken area information. When the processing of Step S43 is performed, this control routine ends.

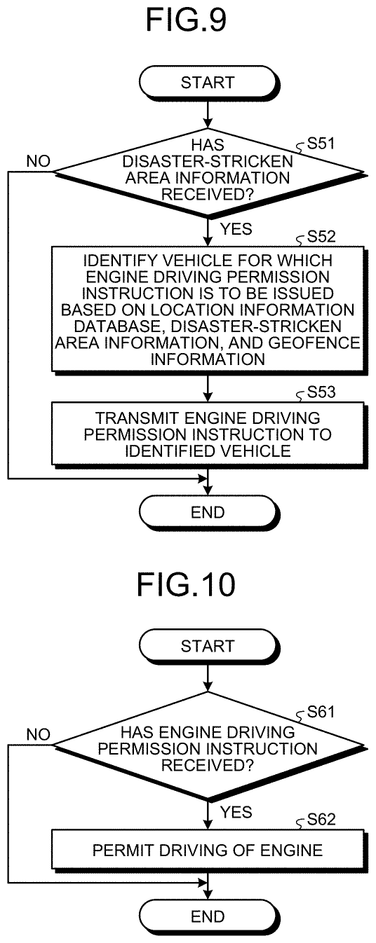

FIG. 9 is a flowchart illustrating a control flow when the vehicle management server receives the disaster-stricken area information. Note that the control illustrated in FIG. 9 is repeatedly performed by the control unit 34 of the vehicle management server 3.

As illustrated in FIG. 9, the vehicle management server 3 determines whether or not the disaster-stricken area information receiving unit 32 has received the disaster-stricken area information (Step S51).

The vehicle management server 3 determines whether or not a supply of electric power is insufficient for an electric power demand in the geofence 5 by the determination processing in Step S51. That is, in a case where the disaster-stricken area information has not been received, it is determined that the supply of electric power is sufficient for the electric power demand in the geofence 5 because no disaster has occurred in the area including geofence 5. On the other hand, in a case where the disaster-stricken area information has been received and the area including geofence 5 is the disaster-stricken area, it is determined that the supply of electric power is insufficient for the electric power demand in the geofence 5.

In a case where the disaster-stricken area information receiving unit 32 has not received the disaster-stricken area information (Step S51: No), this control routine ends.

In a case where the disaster-stricken area information receiving unit 32 has received the disaster-stricken area information (Step S51: Yes), the control unit 34 identifies the vehicle 4 for which the driving permission instruction for the engine 12 is to be issued, based on the location information of the vehicle 4 stored in the location information database 33a, the disaster-stricken area information received by the disaster-stricken area information receiving unit 32, and the geofence information stored in the storage unit 33 (Step S52). In Step S52, the control unit 34 determines whether or not the area where the disaster has occurred (disaster-stricken area) includes at least a part of the geofence 5 based on the disaster-stricken area information and the geofence information. In a case where it is determined that at least a part of the geofence 5 is included in the area where the disaster has occurred, the control unit 34 performs a specific control for the vehicle 4 on the corresponding geofence 5. For example, the vehicle 4 that is already located in the geofence 5 before receiving the disaster-stricken area information and is still located in the geofence 5 after receiving the disaster-stricken area information is identified.

Then, the vehicle management server 3 transmits the driving permission instruction for the engine 12 to the identified vehicle 4 (Step S53). For example, in Step S53, after the occurrence of the disaster, the driving permission instruction for the engine 12 is transmitted to the vehicle 4 to which the driving prohibition instruction for the engine 12 was transmitted before the occurrence of the disaster.

FIG. 10 is a flowchart illustrating a control flow when the vehicle receives the driving permission instruction. Note that the control illustrated in FIG. 10 is repeatedly performed by the control unit 43 of the vehicle 4 in a state in which the vehicle 4 is located in the geofence 5, that is, in a state in which the driving of the engine 12 is prohibited.

As illustrated in FIG. 10, the control unit 43 determines whether or not the communication unit 42 has received the driving permission instruction for the engine 12 (Step S61). In Step S61, it is determined whether or not the driving permission instruction for the engine 12 has been received from the vehicle management server 3 in a state in which the vehicle 4 is located in the geofence 5.

The vehicle 4 determines that the supply of electric power is insufficient for the electric power demand in the geofence 5 by the determination processing in Step S61. That is, in a case where the driving permission instruction for the engine 12 has not been received, it is determined that the supply of electric power is sufficient for the electric power demand in the geofence 5 because no disaster has occurred in the area including the geofence 5. On the other hand, in a case where the driving permission instruction for the engine 12 has been received, the area including the geofence 5 is the disaster-stricken area, and thus, it is determined that the supply of electric power is insufficient for the electric power demand in the geofence 5. As described above, as the driving permission instruction for the engine 12 is received from the vehicle management server 3 in a state in which the vehicle 4 is located in the geofence 5, the vehicle 4 may determine that the supply of electric power is insufficient for the electric power demand in the geofence 5.

In a case where the communication unit 42 has not received the driving permission instruction for the engine 12 (Step S61: No), this control routine ends.

In a case where the communication unit 42 has received the driving permission instruction for the engine 12 (Step S61: Yes), the control unit 43 permits the driving of the engine 12 (Step S62). In Step S62, the control state shifts from a state in which the driving of the engine 12 is prohibited to a state in which the engine 12 may be driven, under the control of the engine control unit 43c.

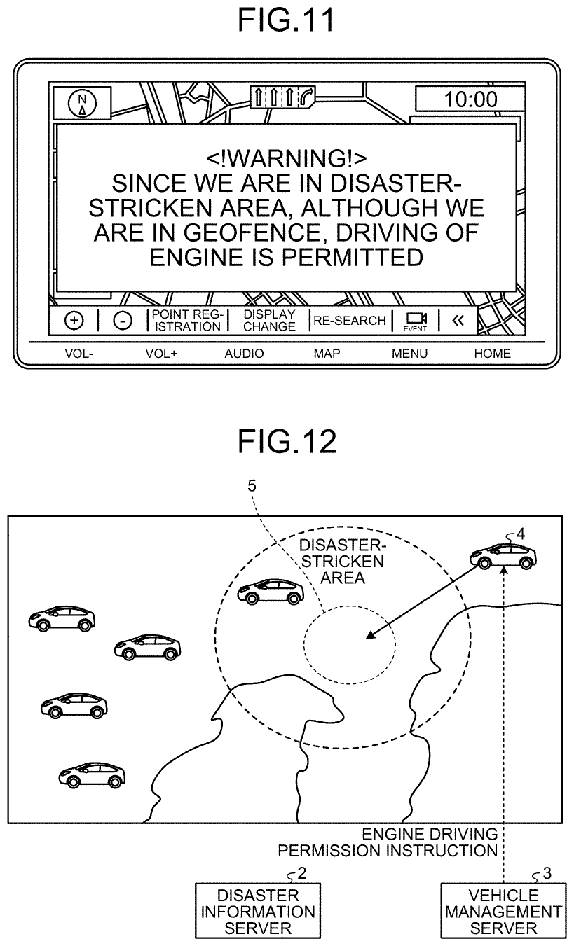

In Step S62, the HMI 44 notifies the driver of information indicating that the driving of the engine 12 is permitted under the control of the HMI control unit 43d. For example, in a case where the HMI 44 is a car navigation device, as illustrated in FIG. 11, information indicating that the driving of the engine 12 is permitted even in the geofence 5 is displayed on a display unit of the car navigation device.

As described above, according to the first embodiment, the driving of the engine 12 is permitted even when the vehicle 4 is located in the geofence 5 in the event of electric power shortage such as a disaster. As a result, electric power may be generated by the motor 11 by using the power of the engine 12, and the consumption of the electric power of the battery 13 may be suppressed. As a result, more electric power on the vehicle side may be supplied to the outside.

In addition, even in a region where the driving of the engine 12 is originally prohibited, the HMI 44 may notify the driver of a control state in which the driving of the engine 12 is permitted. As a result, the driver may recognize that the engine 12 is in a drivable state, such that it is possible to prevent the driver from feeling a sense of incompatibility.

Note that, in the vehicle 4, it is sufficient that the motor 11 is a power source for traveling, and whether or not the engine 12 is a power source for traveling is not particularly limited. The engine 12 only needs to be able to rotate the motor 11.

Further, in the above-described example, the vehicle 4 located in the geofence 5 is identified by the determination processing performed by the vehicle management server 3, but the present disclosure is not limited thereto. For example, the vehicle 4 may perform the processing of determining whether or not the vehicle 4 is located in the geofence 5. In this case, the geofence information is transmitted from the vehicle management server 3 to the vehicle 4. The control unit 43 of the vehicle 4 determines whether or not the vehicle 4 is located in the geofence 5 based on the geofence information received from the vehicle management server 3 and the current location information acquired by the location information acquisition unit 43a.

Further, a method for communication between the vehicle management server 3 and the vehicle 4 is not limited to the method using the network NW such as the Internet line network. For example, a configuration in which wireless communication is performed between a base station installed for each predetermined area and the vehicle 4, and the base station and the vehicle management server 3 may perform communication with each other is also possible.

In addition, in the above-described example, the configuration in which the control instruction is transmitted from the vehicle management server 3 to the vehicle 4, and the vehicle 4 that has received the control instruction executes the control program stored in the storage unit of the vehicle 4 has been described, but the present disclosure is not limited thereto. In short, the control program stored in advance in the storage unit of the vehicle 4 is not limited to be executed in accordance with the control command from the vehicle management server 3, and the control program may be transmitted from the vehicle management server 3 to the vehicle 4.

In a second embodiment, driving of an engine 12 is permitted in a case where a vehicle 4 enters into a geofence 5 from outside the disaster-stricken area after the disaster occurs. Note that a description of the same configuration as that of the first embodiment will be omitted, and reference signs thereof will be cited.

As illustrated in FIG. 12, in an information processing system 1 according to the second embodiment, when the vehicle 4 located outside the geofence 5 enters into the geofence 5 included in a disaster-stricken area, a driving permission instruction for the engine 12 is transmitted from a vehicle management server 3 to the target vehicle 4. For example, a case where the vehicle 4 travels from the outside of the disaster-stricken area to the inside of the geofence 5 for assistance when a supply of electric power is predicted to be insufficient for an electric power demand in the disaster-stricken area is assumed.

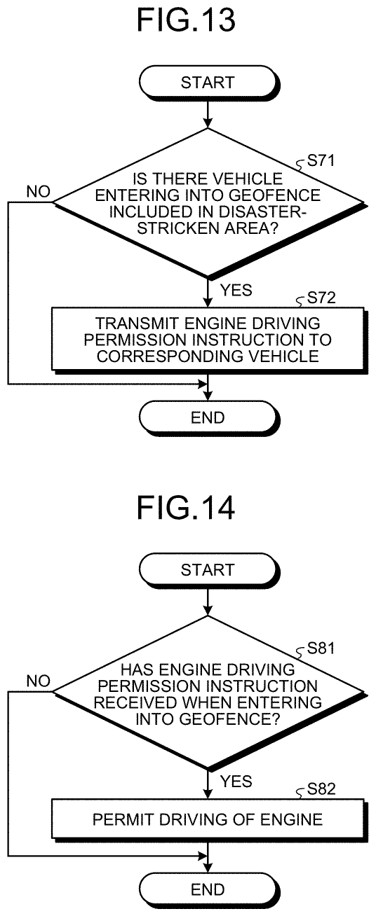

FIG. 13 is a flowchart illustrating a control flow performed by the vehicle management server after the occurrence of the disaster. Note that the control illustrated in FIG. 13 is repeatedly performed by the vehicle management server 3 after receiving disaster-stricken area information.

As illustrated in FIG. 13, a control unit 34 of the vehicle management server 3 determines whether or not there is a vehicle 4 entering into the geofence 5 included in the disaster-stricken area from outside the geofence 5 after the disaster occurs (Step S71). In Step S71, after a disaster-stricken area information receiving unit 32 has received the disaster-stricken area information, the vehicle 4 that has entered into the geofence 5 from outside the geofence 5 is identified based on location information of the vehicle 4 received by a location information receiving unit 31.

In a case where there is no vehicle 4 entering into the geofence 5 from outside the geofence 5 (Step S71: No), this control routine ends.

In a case where there is a vehicle 4 entering into the geofence 5 from outside the geofence 5 (Step S71: Yes), the control unit 34 transmits, to the corresponding vehicle 4, an instruction to permit the driving of the engine 12 (Step S72). In Step S72, the instruction to permit the driving of the engine 12 even in the geofence 5 is transmitted to the vehicle 4 in which the driving of the engine 12 is not restricted. When the processing of Step S72 is performed, the control routine ends.

FIG. 14 is a flowchart illustrating a control flow performed by the vehicle after the occurrence of the disaster. Note that the control illustrated in FIG. 14 is repeatedly performed by a control unit 43 of the vehicle 4 in a state in which the driving of the engine 12 is not prohibited.

As illustrated in FIG. 14, the control unit 43 of the vehicle 4 determines whether or not a communication unit 42 has received the driving permission instruction for the engine 12 (Step S81). In Step S81, it is determined whether or not the driving permission instruction for the engine 12 has been received from the vehicle management server 3 in a state where the driving of the engine 12 of the vehicle 4 is not prohibited. That is, it is determined whether or not the driving permission instruction for the engine 12 has been received at a timing at which the vehicle 4 enters into the geofence 5 from outside the geofence 5.

The vehicle 4 predicts that the supply of electric power is insufficient for the electric power demand in the geofence 5 by the determination processing in Step S81. That is, in a case where the driving permission instruction for the engine 12 has not been received, it is determined that the supply of electric power is sufficient for the electric power demand in the geofence 5 because no disaster has occurred in the area including the geofence 5. On the other hand, in a case where the driving permission instruction for the engine 12 has been received, the area including the geofence 5 is the disaster-stricken area, and thus, it is determined that the supply of electric power is insufficient for the electric power demand in the geofence 5. As described above, when the vehicle 4 enters into the geofence 5 from outside the geofence 5 after occurrence of the disaster, the vehicle 4 may predict that the supply of electric power is insufficient for the electric power demand in the geofence 5 by receiving the driving permission instruction for the engine 12 from the vehicle management server 3.

In a case where the communication unit 42 has not received the driving permission instruction for the engine 12 (Step S81: No), this control routine ends.

In a case where the communication unit 42 has received the driving permission instruction for the engine 12 (Step S81: Yes), an engine control unit 43c of the control unit 43 permits the driving of the engine 12 (Step S82). In Step S82, the state in which the driving of the engine 12 is permitted is continued under the control of the engine control unit 43c.

In Step S82, an HMI 44 notifies the driver of information indicating that the state in which the driving of the engine 12 is permitted is continued, under the control of an HMI control unit 43d. For example, the information indicating that the state in which the driving of the engine 12 is permitted is continued even in the geofence 5 is displayed on the HMI 44 at the timing at which the vehicle 4 enters into the geofence 5.

As described above, according to the second embodiment, even in a case where the vehicle 4 enters into the geofence 5, the driving of the engine 12 is permitted when electric power shortage due to a disaster or the like is predicted. As a result, it is possible to suppress the consumption the electric power of a battery 13 for the vehicle 4 to travel. As a result, more electric power on the vehicle side may be supplied to the outside.

Note that the present disclosure is not limited to each of the above-described embodiments, and may be appropriately changed without departing from the object of the present disclosure.

For example, the vehicle management server 3 may detect information indicating that a disaster has occurred in a predetermined area based not only on the disaster-stricken area information from the disaster information server 2, but also on information posted on a posting site or the like on the Internet or information sent by a public institution such as a local government. For example, in a case of using the information posted on a posting site or the like on the Internet, the vehicle management server 3 detects the information via the network NW. Specifically, the vehicle management server 3 detects the information indicating that a disaster has occurred based on a word posted on a social networking service (SNS) on the Internet or a word frequently tweeted (registered trademark) on a certain day. That is, the vehicle management server 3 acquires information that may identify the area where the disaster has occurred from other than the disaster information server 2. Furthermore, the control unit 34 of the vehicle management server 3 uses information detected on the Internet to determine whether or not at least a part of the geofence 5 is included in the area where the disaster has occurred. In a case where at least a part of the geofence 5 is included in the area where the disaster has occurred, the control unit 34 of the vehicle management server 3 identifies the vehicle 4 located in the geofence 5 included in the area where the disaster has occurred.

Further, the vehicle management server 3 may output the driving permission instruction for the engine 12 by using information sent from an electric power supply company. The electric power supply company sends information indicating that there is a possibility that a supply of electric power is insufficient for an electric power demand in a jurisdiction area including, for example, the inside of the geofence 5. Then, the vehicle management server 3 may determine or predict that the supply of electric power is insufficient for the electric power demand in the geofence 5 based on the information sent from the power supply company. Specifically, in a case where prediction information indicating that the electric power demand is predicted to be tight for the amount of electric power that may be supplied according to a time zone is transmitted as the information sent from the power supply company, the vehicle management server 3 predicts that the supply of electric power is insufficient for the electric power demand in the geofence 5. In this case, an information providing server installed in the power supply company and the vehicle management server 3 are communicably connected to each other via the network NW.

Further, the HMI 44 is not limited to the car navigation device, and may be any device that functions as a notification unit capable of visually, acoustically, or perceivably notifying the driver of information. For example, the HMI 44 may be a voice device such as an audio system capable of performing notification by voice, a device that generates vibration in the driver's seat of the vehicle 4, or the like.

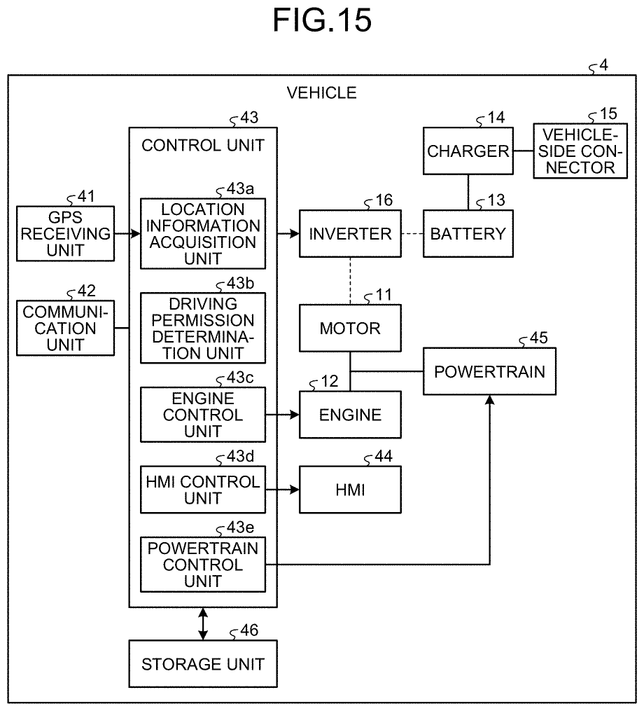

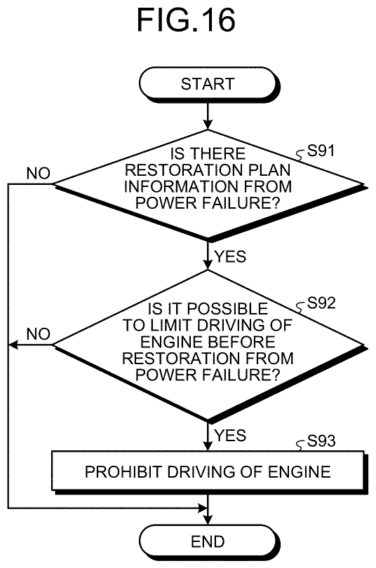

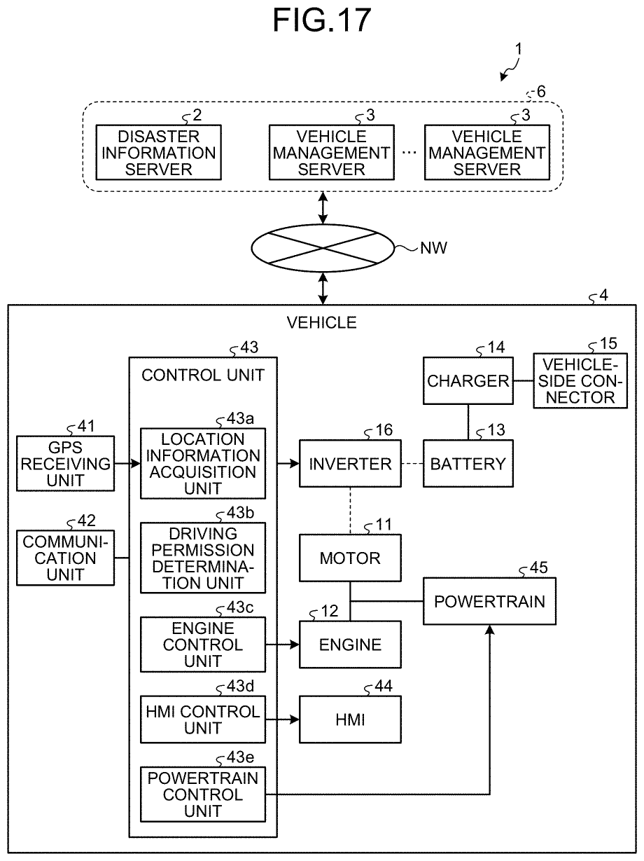

Further, it is possible to configure a modified example of each embodiment described above. For example, it is assumed that after the vehicle 4 located in the geofence 5 is permitted to drive the engine 12 after the occurrence of the disaster, when restoration from the disaster progresses, this permitted state is released. Then, in a case where the disaster is a power failure, it is possible to specify a schedule of the restoration from the power failure based on information provided from an electric power company or the like before the power failure is restored. Although a configuration in which the driving of the engine 12 is prohibited after the restoration from the disaster may be possible, in some cases, the more efficient driving of the power source is enabled by changing the control state of the vehicle 4 before the restoration in accordance with the schedule of the restoration from the disaster. That is, even before the restoration from the disaster, the restoration proceeds as time elapses from the occurrence of the disaster. Therefore, it is preferable to make the control state of the vehicle 4 shift to an appropriate state according to a restoration state. In the modified examples, the system is configured on the assumption that the disaster is a power failure. A configuration of a first modified example is illustrated in FIGS. 15 and 16, and a configured of a second modified example is illustrated in FIG. 17.

First, the first modified example will be described with reference to FIGS. 15 and 16. In the first modified example, even when the vehicle 4 may not perform communication with the disaster information server 2 or the vehicle management server 3 due to the occurrence of the power failure, the vehicle 4 may determine the state of restoration from the power failure in the geofence 5. That is, the first modified example is a stand-alone system in which the vehicle 4 functions alone during the power failure. Note that, in the first modified example, a description of the same configuration as that of each of the above-described embodiments will be omitted, and reference signs thereof will be cited.

FIG. 15 is a functional block diagram illustrating a configuration of the vehicle according to the first modified example. The vehicle 4 of the first modified example further includes a powertrain 45 and a storage unit 46. The control unit 43 further includes a powertrain control unit 43e.

The powertrain control unit 43e controls the powertrain 45. The powertrain 45 is a power transmission device that transmits power output from the motor 11 or the engine 12 to driving wheels. The powertrain 45 includes an automatic transmission and the like. Therefore, the powertrain control unit 43e performs a shift control for controlling the stage of the automatic transmission.

The storage unit 46 stores information for controlling the vehicle 4. For example, the storage unit 46 stores the geofence information. The geofence information may be information stored in advance in the storage unit 46, or may be information received from the vehicle management server 3 before the power failure occurs.

In a case where the control unit 43 determines that the power failure has occurred in the geofence 5 in a state in which the vehicle 4 is located in the geofence 5, the control unit performs the permission control to permit the driving of the engine 12. That is, the control unit 43 determines whether or not the power failure has occurred in the geofence 5. For example, when the communication unit 42 may not acquire information from an external server, the control unit 43 determines that a disaster including at least a power failure has occurred. Alternatively, an image of the surrounding environment of the vehicle 4 is captured by an in-vehicle camera mounted on the vehicle 4, and the control unit 43 may determine whether or not the power failure has occurred around the vehicle 4 based on the captured image. In a case where it is determined that the power failure has occurred in the geofence 5 in this manner, the driving permission determination unit 43b determines that the driving of the engine 12 is permitted. Then, the control unit 43 makes the control state shift from the state in which the driving of the engine 12 is permitted to the state in which the driving of the engine 12 is prohibited according to the schedule of the restoration from the power failure.

FIG. 16 is a flowchart illustrating a control flow when the vehicle determines the schedule of the restoration from the power failure. Note that the control illustrated in FIG. 16 is repeatedly performed by the control unit 43 in a state in which the driving of the engine 12 is permitted while the vehicle 4 is located in the geofence 5.

As illustrated in FIG. 16, the control unit 43 determines whether or not there is restoration plan information from the power failure (Step S91). In Step S91, it is determined whether or not the restoration plan information has been acquired by using the information that may be acquired by the vehicle 4. For example, the control unit 43 may detect the restoration plan information from the power failure based on news information broadcasted on a radio mounted on the vehicle 4. At the time of occurrence of a disaster, disaster information is sent from an FM broadcasting station by a local government or the like of the disaster-stricken area. The disaster information may be acquired by the radio mounted on the vehicle 4. Then, the control unit 43 may detect information output from the radio through a speaker, a microphone, or the like mounted on the vehicle 4, and acquire the disaster information from the information. The disaster information includes restoration plan information indicating the schedule of the restoration from the power failure. Therefore, in Step S91, the control unit 43 may determine the presence or absence of the restoration plan information. In addition, the restoration plan information includes information of a planned restoration time indicating the schedule of the restoration from the power failure.

In a case where there is no restoration plan information from the power failure (Step S91: No), this control routine ends.

In a case where there is the restoration plan information from the power failure (Step S91: Yes), the control unit 43 determines whether or not the driving of the engine 12 may be restricted before the power failure is restored (Step S92). In Step S92, it is determined whether or not to perform a shift from the state in which the driving of the engine 12 is permitted in the geofence 5 to the state in which the driving of the engine 12 is prohibited according to the state of the restoration from the power failure. In the determination processing, the planned restoration time may be used.

In Step S92, the control unit 43 determines whether or not a time from the current time to the planned restoration time is within a predetermined time. The predetermined time is a preset time or a time set according to the state of charge of the battery 13. The control unit 43 may detect a state of charge (SOC), which is the state of charge of battery 13. Therefore, the control unit 43 calculates a time (cruisable time) during which the EV driving state in which the motor 11 is driven by consuming the electric power of the battery 13 may be continued based on the SOC of the battery 13. When calculating the cruisable time, the control unit 43 assumes a case where the motor 11 is driven in an efficient driving region. Then, in a case where the cruisable time is longer than the time from the current time to the planned restoration time, the control unit 43 determines that the driving of the engine 12 may be restricted before the power failure is restored.

In a case where the driving of the engine 12 may not be restricted before the power failure is restored (Step S92: No), this control routine ends.

In a case where the driving of the engine 12 may be restricted before the power failure is restored (Step S92: Yes), the control unit 43 prohibits the driving of the engine 12 (Step S93). In Step S93, the control state shifts from the state in which the driving of the engine 12 is permitted to the state in which the driving of the engine 12 is prohibited. The control unit 43 cancels the state in which the driving of the engine 12 is permitted and performs the prohibition control. In Step S93, the HMI 44 notifies the driver of information indicating that the driving of the engine 12 is prohibited under the control of the HMI control unit 43d. When the processing of Step S93 is performed, this control routine ends.

According to the first modified example, even when the vehicle 4 may not perform communication with the disaster information server 2 or the vehicle management server 3, a shift from the state in which the driving of the engine 12 is permitted to the state in which the driving of the engine 12 is prohibited may be made before the power failure is restored by using the information of the planned restoration time. As a result, it is possible to reduce the amount of CO₂ emission in the geofence 5. Further, in the stand-alone state, the vehicle 4 may change the control state of the power source according to the state of the restoration from the power failure. As a result, the engine 12 and the motor 11 may be efficiently operated.

In addition, when the planned restoration time is updated to the latest information by repeatedly performing the control illustrated in FIG. 16, the control state of the engine 12 may be changed based on the latest planned restoration time. That is, it is possible to cope with the update of the restoration plan information.

Next, the second modified example will be described with reference to FIG. 17. In the second modified example, a state, in which although a power failure has occurred in the geofence 5, the vehicle 4 may perform communication with the disaster information server 2 and the vehicle management server 3 because the power failure has not occurred in a region where the disaster information server 2 and the vehicle management server 3 are installed, is assumed. That is, the second modified example is a server utilization system in which the vehicle 4 may acquire information from an external server during the power failure. Note that, in the second modified example, a description of the same configuration as that of each of the above-described embodiments or the first modified example will be omitted, and reference signs thereof will be cited.

FIG. 17 is a functional block diagram illustrating a configuration of the vehicle according to the second modified example. The information processing system 1 of the second modified example is configured so that the vehicle 4 may perform communication with a server group 6 via the network NW. The server group 6 includes the disaster information server 2 and a plurality of vehicle management servers 3. The disaster information server 2 is a server managed by a local government of the disaster-stricken area, an electric power company that has jurisdiction over the disaster-stricken area, or the like. A plurality of vehicle management servers 3 are installed. For example, even when the vehicle management server 3 in charge of a certain region suffers from the power failure, another vehicle management server 3 in charge of another region makes the vehicle management server 3 suffering from the power failure, such that it is possible to maintain a state in which communication with the vehicle 4 is possible.

In the second modified example, the vehicle 4 may acquire the information provided from the server group 6 during the power failure in the geofence 5. In the second modified example, the geofence information is stored in the vehicle management server 3. Then, the vehicle 4 controls the driving of the engine 12 by using the restoration plan information received from any server of the server group 6. That is, in the second modified example, the control illustrated in FIG. 16 may be performed by the vehicle 4. In this case, in Step S91, it is determined whether or not the restoration plan information from the server group 6 has been received. Then, the vehicle 4 performs the processing of Steps S92 to S93 by using the restoration plan information provided from the server group 6.

According to the second modified example, when the vehicle 4 may perform communication with the disaster information server 2 or the vehicle management server 3, a shift from the state in which the driving of the engine 12 is permitted to the state in which the driving of the engine 12 is prohibited may be made before the power failure is restored by using the information of the planned restoration time. As a result, it is possible to reduce the amount of CO₂ emission in the geofence 5. In addition, the vehicle 4 may change the control state of the power source according to the state of the restoration from the power failure by using the information from the server group 6. As a result, the engine 12 and the motor 11 may be efficiently operated.

Note that, in the second modified example, since the driving of the engine 12 is controlled based on an instruction transmitted from the vehicle management server 3 to the vehicle 4, a part of the control illustrated in FIG. 16 described above may be performed by the vehicle management server 3. For example, the vehicle management server 3 acquires the restoration plan information provided from the disaster information server 2, and performs the processing of Step S92 illustrated in FIG. 16. Specifically, in Step S92, the vehicle management server 3 determines whether or not the driving of the engine 12 may be restricted for each vehicle 4 located in the geofence 5. Further, in a case where it is determined in Step S92 that the driving of the engine 12 may be restricted, the vehicle management server 3 transmits the driving prohibition instruction for the engine 12 to the target vehicle 4. In Step S93, the vehicle 4 prohibits the driving of the engine 12 before the power failure is restored based on the driving prohibition instruction received from the vehicle management server 3.

According to the present disclosure, even in a configuration in which the driving of the internal combustion engine is prohibited when the vehicle is located in the predetermined region, the driving of the internal combustion engine is permitted when the supply of the electric power is insufficient or predicted to be insufficient for the electric power demand in the region. Therefore, the internal combustion engine may be driven to generate electric power by the electric motor, such that electric power consumption of the storage battery may be suppressed. As a result, it is possible to supply a large amount of electric power from the vehicle to the outside in the region.

Even in a region where the driving of the internal combustion engine is originally prohibited, it is possible to notify the driver of a control state in which the driving of the internal combustion engine is permitted. As a result, the driver may recognize the control state in which the internal combustion engine is driven.

In a case where it is determined that the supply of the electric power is insufficient for the electric power demand in the predetermined region in a state in which the driving of the internal combustion engine is prohibited due to being in the predetermined region, the driving of the internal combustion engine may be permitted even in the predetermined region.

In a case where it is predicted that the supply of the electric power is insufficient for the electric power demand in the region where the driving of the internal combustion engine is prohibited when the vehicle enters the region, the driving of the internal combustion engine may be permitted even in the predetermined region.

When a power failure has occurred in the predetermined region, the vehicle may shift from the state in which the driving of the internal combustion engine is permitted to the state in which the driving of the internal combustion engine is prohibited according to the state of restoration from the power failure. As a result, the amount of CO₂ emission may be reduced in the predetermined region.

The vehicle may determine the state of restoration from the power failure based on the time from the current time to the planned restoration time.

The vehicle may shift from the state in which the driving of the internal combustion engine is permitted to the state in which the driving of the internal combustion engine is prohibited in consideration of the time during which the electric driving of the vehicle is possible according to the state of charge of the storage battery.

The driving of the internal combustion engine may be permitted even in the predetermined region based on the driving permission instruction transmitted from the server to the vehicle.

When a power failure has occurred in the predetermined region, the vehicle may shift from the state in which the driving of the internal combustion engine is permitted to the state in which the driving of the internal combustion engine is prohibited based on the information received from the server. As a result, the amount of CO₂ emission may be reduced in the predetermined region.

The vehicle may determine the state of restoration from the power failure based on the time from the current time to the planned restoration time by using the information received from the server.

The vehicle may shift from the state in which the driving of the internal combustion engine is permitted to the state in which the driving of the internal combustion engine is prohibited in consideration of the time during which the electric driving of the vehicle is possible according to the state of charge of the storage battery by using the information received from the server.

Even in a configuration in which the driving of the internal combustion engine is prohibited when the vehicle is located in the predetermined region, the driving of the internal combustion engine is permitted when the supply of the electric power is insufficient or predicted to be insufficient for the electric power demand in the region. Therefore, the internal combustion engine may be driven to generate electric power by the electric motor, such that electric power consumption of the storage battery may be suppressed. As a result, it is possible to supply a large amount of electric power from the vehicle to the outside in the region.

It is possible to determine that the supply of the electric power is insufficient for the electric power demand in the predetermined region, or determine that the supply of the electric power is predicted to be insufficient for the electric power demand in the predetermined region based on the information indicating that a disaster has occurred in a predetermined area in a case where the predetermined region is included in the area where the disaster has occurred.

Even in a configuration in which the driving of the internal combustion engine is prohibited when the vehicle is located in the predetermined region, the driving of the internal combustion engine is permitted when the supply of the electric power is insufficient or predicted to be insufficient for the electric power demand in the region. Therefore, the internal combustion engine may be driven to generate electric power by the electric motor, such that electric power consumption of the storage battery may be suppressed. As a result, it is possible to supply a large amount of electric power from the vehicle to the outside in the region.

It is possible to determine that the supply of the electric power is insufficient for the electric power demand in the predetermined region, or determine that the supply of the electric power is predicted to be insufficient for the electric power demand in the predetermined region based on the information indicating that a disaster has occurred in a predetermined area in a case where the predetermined region is included in the area where the disaster has occurred.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle comprising:
an electric motor adapted for traveling;
a storage battery configured to supply electric power to the electric motor and be charged with electric power from an external power source;
an internal combustion engine configured to rotate the electric motor; and
a controller configured to perform an electric power generation control and a prohibition control, the electric power being generated by the electric motor by using power of the internal combustion engine, and the internal combustion engine being prohibited in a case where the vehicle is positioned in a predetermined region,
wherein the electric power stored in the storage battery is suppliable to an outside, and
the controller is configured to permit driving of the internal combustion engine even in the predetermined region in a case where a supply of electric power is insufficient for an electric power demand in the predetermined region or in a case where the supply of the electric power is predicted to be insufficient for the electric power demand in the predetermined region.

2. The vehicle according to claim 1, further comprising
a notification unit configured to notify a driver of various information,
wherein in a case where the driving of the internal combustion engine is permitted by the controller, the notification unit is configured to notify the driver of information indicating that the driving of the internal combustion engine is permitted even in the predetermined region.

3. The vehicle according to claim 1, wherein in a case where it is determined that the supply of the electric power is insufficient for the electric power demand in the predetermined region in a state in which the driving of the internal combustion engine is prohibited due to being in the predetermined region, the controller is configured to permit the driving of the internal combustion engine.

4. The vehicle according to claim 1, wherein in a case where the supply of the electric power is predicted to be insufficient for the electric power demand in the predetermined region when entering into the predetermined region from outside the predetermined region, the controller is configured to permit the driving of the internal combustion engine even in the predetermined region.

5. The vehicle according to claim 1,
wherein a case where the supply of the electric power is insufficient for the electric power demand in the predetermined region or a case where the supply of the electric power is predicted to be insufficient for the electric power demand in the predetermined region is a case where a power failure occurs, and
the controller is configured to perform a shift from a state in which the driving of the internal combustion engine is permitted in the predetermined region to a state in which the driving of the internal combustion engine is prohibited according to a state of restoration from the power failure.

6. The vehicle according to claim 5,
wherein the controller is configured to acquire information including a planned restoration time indicating a schedule of the restoration from the power failure when the power failure has occurred, and
in a case where a time from a current time to the planned restoration time is within a predetermined time, the controller is configured to perform the shift from the state in which the driving of the internal combustion engine is permitted to the state in which the driving of the internal combustion engine is prohibited.

7. The vehicle according to claim 6, wherein in a case where it is determined that the driving of the internal combustion engine is restrictable before the power failure is restored based on a state of charge of the storage battery and the planned restoration time, the controller is configured to perform the shift from the state in which the driving of the internal combustion engine is permitted to the state in which the driving of the internal combustion engine is prohibited.

8. The vehicle according to claim 1, further comprising
a communication unit configured to perform communication with a server installed outside,
wherein the communication unit is configured to receive a driving prohibition instruction to prohibit the driving of the internal combustion engine and a driving permission instruction to permit the driving of the internal combustion engine, the driving prohibition instruction and the driving permission instruction being transmitted from the server,
in a case where the driving prohibition instruction has been received by the communication unit, the controller is configured to prohibit the driving of the internal combustion engine in the predetermined region, and
in a case where the driving permission instruction has been received by the communication unit, the controller is configured to
determine that the supply of the electric power is insufficient for the electric power demand in the predetermined region, or the supply of the electric power is predicted to be insufficient for the electric power demand in the predetermined region, and
permit the driving of the internal combustion engine even in the predetermined region.

9. The vehicle according to claim 8,
wherein a case where the supply of the electric power is insufficient for the electric power demand in the predetermined region or a case where the supply of the electric power is predicted to be insufficient for the electric power demand in the predetermined region is a case where a power failure occurs,
the communication unit is configured to receive restoration plan information regarding a schedule of restoration from the power failure, transmitted from the server, and
the controller is configured to perform a shift from a state in which the driving of the internal combustion engine is permitted in the predetermined region to a state in which the driving of the internal combustion engine is prohibited according to a state of the restoration from the power failure based on the restoration plan information.

10. The vehicle according to claim 9,
wherein the controller is configured to acquire a planned restoration time indicating the schedule of the restoration from the power failure, included in the restoration plan information, and
in a case where a time from a current time to the planned restoration time is within a predetermined time, the controller is configured to perform the shift from the state in which the driving of the internal combustion engine is permitted to the state in which the driving of the internal combustion engine is prohibited.

11. The vehicle according to claim 10,
wherein in a case where it is determined that the driving of the internal combustion engine is restrictable before the power failure is restored based on a state of charge of the storage battery and the planned restoration time, the controller is configured to perform the shift from the state in which the driving of the internal combustion engine is permitted to the state in which the driving of the internal combustion engine is prohibited.

12. A server comprising
a processor comprising hardware, the processor being configured to:
acquire location information of a vehicle from the vehicle;
output a driving prohibition instruction to prohibit driving of an internal combustion engine mounted on the vehicle to the vehicle located in a predetermined region based on the location information of the vehicle; and
output a driving permission instruction to permit the driving of the internal combustion engine to the vehicle located in the predetermined region in a case where a supply of electric power is insufficient for an electric power demand in the predetermined region, or in a case where the supply of the electric power is predicted to be insufficient for the electric power demand in the predetermined region.

13. The server according to claim 12, wherein the processor is configured to:
determine, based on information indicating that a disaster has occurred in a predetermined area in a case where the predetermined region is included in the area where the disaster has occurred,
that the supply of the electric power is insufficient for the electric power demand in the predetermined region, or
that the supply of the electric power is predicted to be insufficient for the electric power demand in the predetermined region; and
output the driving permission instruction to the vehicle located in the predetermined region.

14. An information processing system comprising:
a server comprising a first processor comprising hardware; and
a vehicle comprising
a second processor comprising hardware,
an electric motor adapted for traveling,
an internal combustion engine configured to rotate the electric motor, and
a storage battery configured to store electric power that is suppliable to the electric motor and an outside,
wherein the server and the vehicle are communicable with each other,
the first processor is configured to
output a driving prohibition instruction to prohibit driving of the internal combustion engine to the vehicle located in a predetermined region based on location information of the vehicle acquired from the vehicle,
output, in a case where a supply of electric power is insufficient for an electric power demand in the predetermined region, or in a case where the supply of the electric power is predicted to be insufficient for the electric power demand in the predetermined region, a driving permission instruction to permit the driving of the internal combustion engine to the vehicle located in the predetermined region, and
the second processor is configured to
prohibit the driving of the internal combustion engine in the predetermined region in a case where the driving prohibition instruction has been received from the server, and
permit the driving of the internal combustion engine even in the predetermined region in a case where the driving permission instruction has been received from the server.

15. The information processing system according to claim 14, wherein the first processor is configured to
determine, based on information indicating that a disaster has occurred in a predetermined area in a case where the predetermined region is included in the area where the disaster has occurred,
that the supply of the electric power is insufficient for the electric power demand in the predetermined region, or
that the supply of the electric power is predicted to be insufficient for the electric power demand in the predetermined region, and
output the driving permission instruction to the vehicle located in the predetermined region.
